(19) United States
(12) Patent Application Publication
(10) Pub. No.: US 2024/0009913 A1
(43) Pub. Date: Jan. 11, 2024

(54) APPARATUS FOR FORMING PLASTIC PREFORMS INTO PLASTIC CONTAINERS WITH A COVER DEVICE ARRANGED ON THE STRETCHING DEVICE

(71) Applicant: KRONES AG, Neutraubling (DE)

(72) Inventors: Christian WITTMANN, Hemau (DE); Florian GELTINGER, Donaustauf (DE); Daniel THEEN, Lappersdorf (DE)

(21) Appl. No.: 18/218,489

(22) Filed: Jul. 5, 2023

(30) Foreign Application Priority Data
Jul. 5, 2022 (DE) 10 2022 116 735.6

(51) Int. Cl. B29C 49/46; B29C 49/42; B29C 49/28; B29C 49/12

(52) U.S. Cl. CPC B29C 49/46; B29C 49/42095; B29C 49/28; B29C 49/42065; B29C 49/12; B29L 2031/712

(57) ABSTRACT

An apparatus for forming plastic preforms into plastic containers, includes a transport device, which has a rotatable transport carrier on which a plurality of forming stations is arranged. The forming stations each have application devices for applying fluid medium to the plastic preforms. The forming stations each have stretching devices for stretching the plastic preforms in the longitudinal direction thereof. The stretching devices each have at least one stretching rod which can be moved in the longitudinal direction of the plastic preforms. The apparatus has a clean room, within which the plastic preforms are expanded into the plastic containers, and a sealing device in order to seal the clean room from a non-sterile environment. The sealing device has at least one circumferential channel which can be filled with a liquid, characterized in that the clean room is closed with a cover device, and this cover device is fastened at least to at least one stretching device by fastening devices.

### BACKGROUND OF THE INVENTION

The present invention relates to an apparatus and a method for forming plastic preforms into plastic containers. Such apparatuses and methods have long been known from the prior art. In recent times, apparatuses and methods have also become known, in which the forming of the plastic preforms into the plastic containers takes place within a clean room. In this way, it is possible, for example, that the entire forming process already takes place under sterile conditions and the manufactured plastic containers therefore subsequently do not have to be sterilized again or only have to be sterilized with reduced effort. Furthermore known from the prior art are so-called blow molding machines which, during the blowing process, also stretch the plastic preforms in their longitudinal direction. These are in particular so-called stretch blow molding machines.

In the prior art, so-called water locks or hydraulic seals are usually used for sealing the clean room. They usually have a circumferential channel which is filled with a liquid and into which a blade or a circumferential wall dips. This blade usually belongs to a rotating part of the system and the circumferential channel is arranged in a stationary manner.

Two such water locks are provided in the internal prior art of the applicant. The upper of these two water locks is held at the moment by a massive blowing wheel. This blowing wheel is thus designed as a bracing part.

This blowing wheel is very heavy and deforms as a whole during thermal loading, in particular during the sterilization. Thereafter, this affects the individual stretching devices mounted on the blowing wheel. In particular, the set transfer positions may become unclean, which in turn can lead to failures.

The present invention is therefore based on the object of designing such apparatuses and methods in a reliable manner. In particular, the influences of thermal expansions are also to be reduced. This is achieved according to the invention by the subject matter of the independent claims. Advantageous embodiments and developments are the subject matter of the dependent claims.

### SUMMARY OF THE INVENTION

An apparatus according to the invention for forming plastic preforms into plastic containers has a transport device which transports the plastic preforms to be formed along a predetermined transport path and/or which is suitable and intended for transporting the plastic preforms along a predetermined transport path, wherein the transport device has a rotatable transport carrier on which a plurality of forming stations is arranged, and wherein these forming stations each have blow molding devices, within which the plastic preforms can be formed into the plastic containers by applying a fluid and in particular gaseous medium thereto. Preferably, the transport path extends circularly.

Furthermore, the forming stations each have application devices in order to apply the fluid medium to the plastic preforms, wherein the forming stations each have stretching devices for stretching the plastic preforms in the longitudinal direction thereof, and these stretching devices each have at least one stretching rod which can be moved in the longitudinal direction of the plastic preforms and can be inserted into the plastic preforms.

Furthermore, the apparatus has a clean room, within which the plastic preforms can be and/or are expanded into the plastic containers, and a sealing device in order to seal the clean room from a non-sterile environment.

Furthermore, this sealing device has at least one and preferably at least two circumferential channels which can be or are filled with a liquid.

According to the invention, the clean room is closed with a cover device and this cover apparatus is fastened at least to at least one stretching unit by means of a fastening device. In another embodiment according to the invention, the cover device is designed as a non-supporting device. In addition, it is also conceivable to combine these two embodiments according to the invention with one another.

It is thus proposed that the cover device is fastened at least to one stretching unit. In addition, the cover device is preferably fastened to multiple stretching units. In addition, it is also conceivable for the cover device to be additionally fastened to other system parts and/or assemblies.

It is thus conceivable that the cover device is fastened not only to the stretching unit(s), for example by means of bolts (as described in more detail below), but also to other points (e.g., to various columns which are arranged on the blowing wheel or the transport carrier).

The bolts described in more detail below are advantageously suitable for receiving the weight of the cover device.

In a further embodiment according to the invention, the clean room is closed with a cover device, and this cover device is arranged, by means of fastening devices, on at least one supporting element within the clean room and preferably on multiple supporting elements within the clean room.

These supporting elements are preferably selected from a group of supporting elements, which contains stretching unit, mold carrier holder, a rear insulator wall, columns which are arranged on the transport carrier, and the like.

A design as a non-supporting device is in particular understood to mean that the cover device is neither suitable nor intended to support components of the apparatus, such as drives, forming stations and the like.

The cover apparatus can thus be manufactured, for example, in a material thickness and/or a material that does not enable a supporting and/or bracing function.

The apparatus preferably has a stationary part and a rotatable part. Preferably, the aforementioned transport carrier is a component of the rotatable part of the device. Preferably, the mentioned cover device is also a component of the rotatable or rotating part of the apparatus.

The at least one aforementioned circumferential channel is preferably a component of the stationary part of the apparatus. The apparatus preferably has a circumferential wall which dips into a liquid medium, for example water, located in the channel. This wall is preferably a component of the rotating part of the apparatus.

The aforementioned circumferential channel is preferably annular. Particularly preferably, the clean room has a toroidal shape. Particularly preferably, the clean room is delimited by said annular channel and preferably a further correspondingly annular channel. Particularly preferably, the clean room is delimited by at least one wall. Particularly preferably, at least two walls are provided, which delimit the clean room, wherein one wall can be moved relative to the other wall and can in particular be rotated.

Particularly preferably, at least one drive device is provided, and a plurality of drive devices for driving the stretching rods is preferably provided. It is possible for this drive device to be arranged outside or inside the clean room.

Particularly preferably, the drive device can be a guide cam on which a guide roller rolls. In addition, however, pneumatic drives, electric drive devices or hydraulic drive devices could also be used. Particularly preferably, the drive device is a linear motor.

In a preferred embodiment, the apparatus has a drive device for rotating the rotatable transport carrier, wherein this drive device is preferably arranged outside the clean room.

Furthermore, the apparatus preferably also has at least one and preferably a plurality of drive devices which advance the application device toward the plastic preforms in order to apply the fluid medium to the latter. Particularly preferably, the blow molding device is designed in at least three parts and has two side parts and a base part. Furthermore, blow mold carriers are also provided, to which the side parts of the blow molding device are fastened and which enable opening and closing of the blow molding device by a pivoting movement.

In a preferred embodiment, the cover device is fastened at least to multiple stretching devices. Particularly preferably, the cover device is fastened to all stretching devices.

In a preferred embodiment, the upper part of the rotating insulator, i.e., the cover device, is therefore preferably fastened to the stretching devices via multiple fastening devices. Particularly preferably, the cover device only delimits the clean room and is itself designed to be non-supporting. In this way, the cover device can be produced from comparatively lightweight or thin materials.

In a further, advantageous embodiment, the cover device is fastened to multiple stretching devices by means of a plurality of connecting elements and in particular connecting bolts. In this embodiment, connecting bolts therefore preferably serve as connecting elements. In this case, it is possible for the cover device to be fastened to the respective stretching devices by means of a connecting element and in particular a connecting bolt, or for the cover device to be fastened to the respective stretching devices by means of at least two connecting elements and in particular connecting bolts.

Particularly preferably, the connecting elements are bendable (and in particular reversibly bendable) and in particular elastic, in particular in order to absorb and/or intercept a thermally induced expansion of the cover device. This achieves that the mechanical hold between the cover device and the stretching devices is provided independently of the expansion.

This also achieves that an expansion of the cover device does not lead to a displacement of the stretching devices and the position of the stretching devices is therefore not impaired thereby. Particularly preferably, the connecting elements are manufactured from a material that is selected from a group of materials which contains steel and stainless steel. Preferably, the connecting elements are manufactured from a material that has a higher strength than a wall and in particular a wall delimiting the clean room.

Preferably, the fastening devices (which are in particular bolts) have a length that is greater than 90 mm, preferably greater than 100 mm, preferably greater than 110 mm, preferably greater than 120 mm, and particularly preferably greater than 130 mm.

Preferably, the fastening devices (which are in particular bolts) have a length that is smaller than 200 mm, preferably smaller than 180 mm, preferably smaller than 160 mm, preferably smaller than 150 mm, and particularly preferably smaller than 130 mm.

Preferably, these connecting elements and in particular bending bolts absorb the majority of the thermal deformation of the cover device. Preferably, these connecting elements absorb at least 70%, preferably at least 80%, and preferably at least 90% of the deformation of the cover device. In this way, the stretching devices are less loaded and particularly preferably also thermally decoupled from the cover device. This ensures that the thermal deformation of the clean room or of the insulator has no influence on the transfer positions.

Particularly preferably, the fastening elements are designed such that they can absorb the static weight of the cover device. In particular, they can bend as mentioned above when the cover, or the cover device, expands thermally (in a thermally induced manner).

In a further embodiment, the cover device is mounted in a floating manner. In particular, it can therefore move within predetermined limits in a horizontal direction. This is noncritical since, as mentioned above, the cover device is preferably not designed as a supporting device.

Preferably, a movement range of the cover device in a horizontal plane that is greater than 1 mm, preferably greater than 2 mm, and preferably greater than 3 mm is permitted.

Preferably, a movement range of the cover device in a horizontal plane that is less than 5 cm, preferably less than 3 cm, and preferably less than 1 cm is permitted.

In a further, advantageous embodiment, the stretching device or the stretching devices and the cover device are thermally decoupled from one another. This can in particular be achieved by the connecting elements consisting of a thermally non-conductive material or a thermal insulator.

Particularly preferably, the sealing device has a circumferential wall which projects into the circumferential channel, wherein this wall is preferably designed to be rotatable.

Particularly preferably, the aforementioned circumferential channel is also fastened to at least one and preferably to a multitude of stretching devices. In this way, the connection between the circumferential channel and the stretching devices can be kept very stable. Particularly preferably, the stretching devices and/or components of the stretching devices are designed as supporting elements.

In a further, advantageous embodiment, the cover device has a substantially circular or annular shape. In this respect, substantially circular is understood to mean that any elements of the cover device, such as holes or fastening means or the like, are neglected in the assessment of circularity or of annularity.

In a further, advantageous embodiment, the cover device has a material thickness (which extends in particular in a vertical direction and/or the longitudinal direction of the plastic preforms) that is smaller than 50 mm, preferably smaller than 40 mm, and particularly preferably smaller than 30 mm, and particularly preferably smaller than 20 mm.

In a further, advantageous embodiment, the cover device has a material thickness that is greater than 1 mm, preferably greater than 2 mm, and preferably greater than 3 mm.

In a preferred embodiment, the cover device is formed in one piece. However, it is also conceivable for the cover device to be composed of multiple components.

In a further, preferred embodiment, the cover device is manufactured from aluminum or a plastic.

In a further, preferred embodiment, the cover device can be detached from the stretching devices. In particular, the clean room can be opened in this way.

The present invention is furthermore directed to a method for forming plastic preforms into plastic containers, wherein a transport device transports the plastic preforms to be formed along a predetermined transport path, and wherein the transport device has a rotatable carrier on which a plurality of forming stations is arranged, wherein these forming stations each have blow molding devices within which the plastic preforms are formed into the plastic containers by applying a fluid medium thereto, and the forming stations each have application devices which apply a fluid and in particular gaseous medium (and in particular sterile air) to the plastic preforms, wherein the forming stations each have stretching devices for stretching the plastic preforms in the longitudinal direction thereof, or stretching devices which stretch the plastic preforms in the longitudinal directions thereof, and these stretching devices each have at least one stretching rod which can be moved and/or moves in the longitudinal direction of the plastic preforms and which is introduced into the plastic preforms.

Furthermore, the apparatus has a clean room, within which the plastic preforms are expanded into plastic containers, and a sealing device, which seals the clean room from a non-sterile environment. In this case, the sealing device preferably has at least one circumferential channel filled with a liquid.

According to the invention, the clean room is closed with a cover device and this cover device is fastened or can be fastened to at least one stretching unit by means of fastening devices. In a further embodiment according to the invention, the cover device is designed as a non-supporting device.

Particularly preferably, connecting elements and in particular connecting bolts connect the cover device to the stretching devices.

Particularly preferably, these connecting elements compensate for a possibly occurring thermal expansion of the cover device.

Particularly preferably, the cover device is designed as a non-supporting unit of the apparatus.

Particularly preferably, the cover device is thermally insulated from at least one stretching unit and preferably multiple and particularly preferably all stretching devices.

In a further, preferred method, a rotational movement of the cover device is coupled to a rotational movement of the transport carrier.

### BRIEF DESCRIPTION OF THE DRAWINGS

Further advantages and embodiments can be seen in the accompanying drawings:

In the figures:

FIG. 1 shows a schematic representation of a apparatus according to the invention; and

FIG. 2 shows a partial view of an apparatus according to the invention.

### DETAILED DESCRIPTION OF THE INVENTION

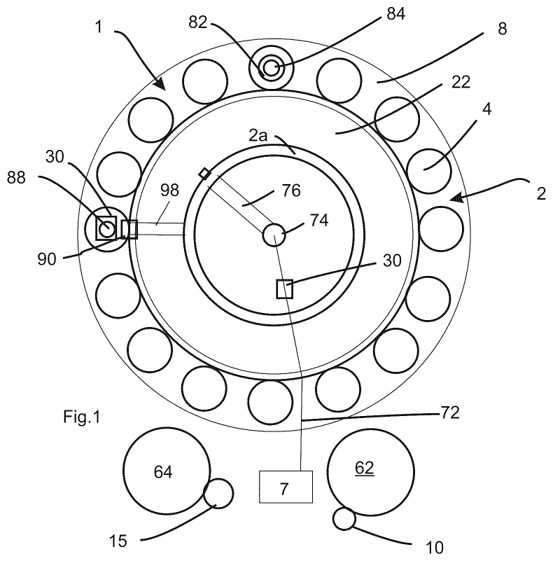

FIG. 1 shows an apparatus 1 for forming plastic preforms 10 into plastic containers 15. This apparatus has a rotatable carrier 22 on which a multitude of forming stations 4 is arranged. These individual forming stations each have blow molding devices 82, which in their interior form a cavity for expanding the plastic preforms.

Reference sign 84 denotes an application device which serves for expanding the plastic preforms 10. This can be, for example, a blowing nozzle which can be placed onto an opening of the plastic preforms in order to expand the latter. In addition, it is also conceivable to seal the blowing nozzle on the blow molding device.

Reference sign 90 denotes a valve arrangement, such as a valve block, which preferably has a plurality of valves which control the application of different pressure levels to the plastic preforms.

In a preferred method, first a pre-blowing pressure P1, then at least one intermediate blowing pressure Pi that is higher than the pre-blowing pressure, and finally a final blow molding pressure P2 that is higher than the intermediate blowing pressure Pi are applied to the plastic preforms. After the expansion of the plastic containers, the pressures or the compressed air are preferably returned from the container to the individual pressure reservoirs.

Reference sign 88 denotes a stretching rod which serves to stretch the plastic preforms in their longitudinal direction. Preferably, all forming stations have such blow molds 82 and stretching rods 88. This stretching rod is preferably a component of a stretching device denoted by 30.

The number of these forming stations 4 is preferably between 2 and 100, preferably between 4 and 60, preferably between 6 and 40.

The plastic preforms 10 are fed to the device via a first transport device 62, such as, in particular but not exclusively, a transport star. The plastic containers 15 are transported away via a second transport device 64.

Reference sign 7 denotes a pressure supply device, such as a compressor or a compressed-air connection. The compressed air is conveyed via a connecting line 72 to a rotary distributor 74 and delivered from the latter via a further line 76 to the reservoir 2a, which is here an annular channel. This rotary distributor is thus preferably used to guide air from a stationary part of the apparatus into a rotating part of the apparatus.

In addition to this annular channel 2a shown, further annular channels are preferably provided, which are however covered by the annular channel 2a in the illustration shown in FIG. 1, for example are below it. Reference sign 98 denotes a connecting line which delivers the compressed air to a forming station 4 or the valve block 90 thereof. Preferably, each of the annular channels is connected to all forming stations via corresponding connecting lines. This connecting line is preferably arranged in the rotating part of the apparatus.

Reference sign 8 schematically denotes a clean room, which is preferably annular and surrounds the transport path of the plastic preforms 10. Preferably, a (geometric) axis of rotation with respect to which the transport carrier 22 can be rotated is arranged outside the clean room 8. Preferably, the clean room is sealed from the non-sterile environment by means of a sealing device, which preferably has at least two water locks.

Furthermore, the apparatus has a cover device (not shown in FIG. 1), which delimits the clean room 8 upward. This cover device is preferably arranged on at least one of the stretching devices 30.

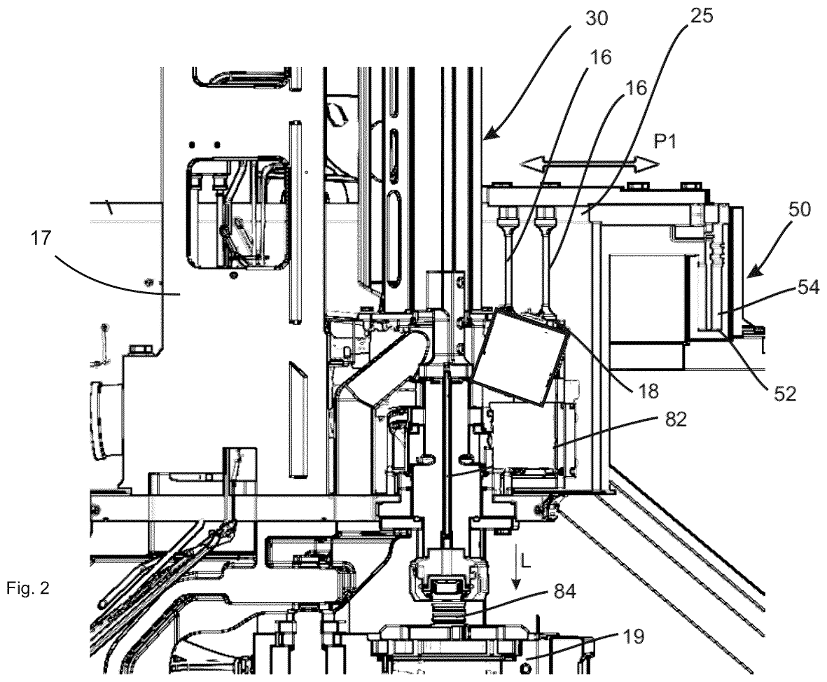

FIG. 2 shows a side view of an apparatus according to the invention. In this case, a forming station which has a stretching device 30 is shown partially. This stretching device has a stretching rod 82 which can be inserted into the plastic preforms by a movement in the longitudinal direction L (which is, in particular, also a longitudinal direction of the plastic preforms to be expanded).

Reference sign 17 denotes a carrier of the stretching device 30. This carrier is preferably dimensioned such that it can support the stretching device. Reference sign 18 denotes a valve block or a valve arrangement, which preferably has a plurality of valves by means of which pressure is applied to the plastic preforms.

Reference sign 19 denotes a blow mold carrier on which a blow molding apparatus (not shown) is arranged.

Reference sign 25 denotes a cover device, which delimits the clean room upward. This cover device is arranged via, here two, connecting elements 16, in particular connecting bolts 16, on the stretching device 30 and also on further stretching devices (not shown). These connecting elements are furthermore arranged on the carrier 18 of the stretching device 30.

Reference sign P1 denotes the direction in which the cover device is movably and/or floatingly mounted and in which (thermally induced) expansions of the cover device can also be absorbed.

The connecting elements are preferably designed as bolts and in particular as elongated bolts.

Preferably, these connecting elements are arranged in the longitudinal direction L or substantially in the longitudinal direction L (the latter means that an extension direction of the connecting elements deviates by less than 10°, preferably by less than 8° preferably by less than 6° and particularly preferably by less than 4° from the longitudinal direction.

The connecting elements preferably have a length that is greater than 1 cm, preferably greater than 1.5 cm, preferably greater than 2 cm, and preferably greater than 2.5 cm.

The connecting elements preferably have a length that is smaller than 20 cm, and preferably greater than 10 cm.

Reference sign 50 denotes a sealing device which delimits the clean room from the environment. This sealing device preferably has a circumferential channel 52 which is arranged in particular in a stationary manner. A circumferential wall 54 preferably dips into this circumferential channel or into the liquid (not shown) located therein. This circumferential wall 54 is preferably arranged on the cover device 20.

The sealing device 50 preferably also has at least one further circumferential channel which is not shown in FIG. 2 and which is preferably located below the circumferential channel 52 shown. These channels are preferably connected to one another by a circumferential wall.

Furthermore, the cover device is preferably fastened to further devices of the apparatus, which can take place, for example, by means of a fastening plate 23. In this case, for example, such a connection can be established with the column on which the transport carrier, i.e., the blowing wheel, is arranged.

Reference signs 2a and 2b denote two reservoirs and in particular annular channels, which serve for storing compressed air.

In a further, preferred embodiment, components of the stretching devices 30 and in particular a housing of the stretching device 30 extends through the cover device 25.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. An apparatus for forming plastic preforms into plastic containers, comprising a transport device, which transports the plastic preforms to be formed along a predetermined transport path, wherein the transport device has a rotatable transport carrier on which a plurality of forming stations is arranged, wherein these forming stations each have blow molding devices within which the plastic preforms can be formed into the plastic containers by applying a fluid medium thereto, and the forming stations each have application devices in order to apply the fluid medium to the plastic preforms, wherein the forming stations each have stretching devices for stretching the plastic preforms in the longitudinal direction thereof, and these stretching devices each have at least one stretching rod which can be moved in the longitudinal direction of the plastic preforms and which can be inserted into the plastic preforms, and wherein the apparatus has a clean room, within which the plastic preforms are expanded into the plastic containers, and a sealing device configured to seal the clean room from a non-sterile environment,
wherein
the clean room is closed with a cover device, and this cover device is fastened by fastening devices at least to at least one stretching device and/or the cover device is designed as a non-supporting device.

2. An apparatus for forming plastic preforms into plastic containers, comprising a transport device, which transports the plastic preforms to be formed along a predetermined transport path, wherein the transport device has a rotatable transport carrier on which a plurality of forming stations is arranged, wherein these forming stations each have blow molding devices within which the plastic preforms can be formed into the plastic containers by applying a fluid medium thereto, and the forming stations each have application devices in order to apply the fluid medium to the plastic preforms, wherein the forming stations each have stretching devices for stretching the plastic preforms in the longitudinal direction thereof, and these stretching devices each have at least one stretching rod which can be moved in the longitudinal direction of the plastic preforms and which can be inserted into the plastic preforms, and wherein the apparatus has a clean room, within which the plastic preforms are expanded into the plastic containers, and a sealing device configured to seal the clean room from a non-sterile environment,
wherein
the clean room is closed with a cover device, and this cover device is arranged by fastening devices to at least one supporting element within the clean room.

3. The apparatus according to claim 1,
wherein
the cover device is designed as a non-supporting device.

4. The apparatus according to claim 1,
wherein
the cover device is fastened at least to multiple stretching devices.

5. The apparatus according to claim 1,
wherein
the cover device is fastened to multiple stretching devices by a plurality of connecting elements.

6. The apparatus according to claim 1,
wherein
the connecting elements are designed to be bendable in order to absorb a thermally induced expansion of the cover device.

7. The apparatus according to claim 1,
wherein
the cover device is mounted in a floating manner.

8. The apparatus according to claim 1,
wherein
the stretching device and the cover device are thermally decoupled from one another.

9. The apparatus according to claim 1,
wherein
the sealing device has a circumferential wall which projects into a circumferential channel, wherein this wall is designed to be rotatable.

10. The apparatus according to claim 9,
wherein
the circumferential channel is fastened to at least one stretching devices.

11. The apparatus according to claim 1,
wherein
the cover device has a substantially circular or annular shape and/or the cover device has a material thickness that is smaller than 50 mm, and/or the cover device has a material thickness that is greater than 1 mm.

12. A method for forming plastic preforms into plastic containers, wherein a transport device transports the plastic preforms to be formed along a predetermined transport path, wherein the transport device has a rotatable transport carrier on which a plurality of forming stations is arranged, wherein these forming stations each have blow molding devices within which the plastic preforms are formed into the plastic containers by applying a fluid medium thereto, and the forming stations each have application devices which apply the fluid medium to the plastic preforms, wherein the forming stations each have stretching devices for stretching the plastic preforms in the longitudinal direction thereof, and these stretching devices each have at least one stretching rod which can be moved in the longitudinal direction of the plastic preforms and which is inserted into the plastic preforms, and wherein the apparatus has a clean room, within which the plastic preforms are expanded into the plastic containers, and a sealing device configured to seal the clean room from a non-sterile environment, and this sealing device has at least one circumferential channel filled with a liquid,
wherein
the clean room is closed with a cover device, and this cover device is fastened by fastening devices at least to at least one stretching device and/or the cover device is designed as a non-supporting device.

13. The method according to claim 12,
wherein
the cover device is thermally insulated from at least one stretching device.
